(19) United States
(12) Patent Application Publication
(10) Pub. No.: US 2014/0012735 A1
(43) Pub. Date: Jan. 9, 2014

(54) Bank Mall

(71) Applicant: Shaya Saks, Brooklyn, NY (US)

(72) Inventor: Shaya Saks, Brooklyn, NY (US)

(21) Appl. No.: 13/888,204

(22) Filed: May 6, 2013

Related U.S. Application Data
(60) Provisional application No. 61/688,519, filed on May 16, 2012.

(51) Int. Cl. G06Q 40/00

(52) U.S. Cl. CPC G06Q 40/00
USPC 705/38; 705/39

(57) ABSTRACT

The invention provides a messenger service for businesses as well as consumers that provides delivery and pickup of banking transactions. Additionally, the invention provides the ability to make a deposit at any bank to any other bank. The invention also provides a bank branch location having branches for multiple banking institutions at one location. Additionally, the invention provides a window covering all banks with the Bank Mall establishment possessing proprietary computer software that links to their contracted banks, allowing the Bank Mall to process the transactions.

### CLAIM OF PRIORITY

This patent application claims priority under 35 USC 119(e)(1) from U.S. Provisional Patent Application Ser. No. 61/688,519 filed May 16, 2012, of common inventorship herewith entitled, “Bank Mall.”

### FIELD OF THE INVENTION

The present invention pertains to the field of banking, and more specifically to the field of automated banking services.

### BACKGROUND OF THE INVENTION

The prior art has put forth several designs for automated banking services. Among these are:

US Patent 2008/0126245 to Robert Rosenberg describes a system and method for providing personal financial services at a single branch location for customers having accounts at a plurality of private financial institutions. First and second customers provide information representing their respective private financial accounts. The accounts may be held at different institutions. The branch location provides personal financial services to enable the first customer and the second customer to conduct transactions for their respective accounts. Preferably, a network of branches locations are provided that are each operable to provide personal bank services for a plurality of accounts held at a plurality of private financial institutions.

US Patent 2002/0107767 to Kevin J. McClair and Les Dinkin describes a national branch network facility for providing financial transaction conducting capability as well as financial products sales capability and financial services. This facility also provides non financial products sales and services activity capability to businesses and affluent individuals who are customers of member institutions of the network which is owned, operated, managed, and maintained by a third party as well as a network of such facilities.

U.S. Pat. No. 7,246,741 to Thomas Lee Cable and William Malcolm Ross describes Convenient, efficient, and cost-effective processing of a financial transaction. Banking customers can drop-off financial transaction requests at any of a plurality of geographically dispersed collection sites that operate on behalf of an expedited mail delivery service. Each collection site can aggregate received transaction requests into a package to be delivered to a transaction processing center via expedited mail delivery. Each transaction request can be contained within an envelope. Utilizing unique identifying insignias on each envelope and package, the location of each envelope and package can be tracked during the expedited mail delivery. Upon receipt, the transaction processing center can process each transaction request.

None of these prior art references describe the present invention.

### SUMMARY OF THE INVENTION

It is an object of the present invention to provide an automated messenger service for businesses and consumers that provides delivery and pickup of banking services.

It is an additional object of the present invention to provide the ability to make a deposit at any bank to any other bank.

It is a further object of the present invention to provide a bank branch location having branches for multiple banking institutions at one location.

### BRIEF DESCRIPTION OF THE DRAWINGS

FIG. 1 is an illustrative perspective view of people physically standing in line at a bank and waiting to make a bank transaction.

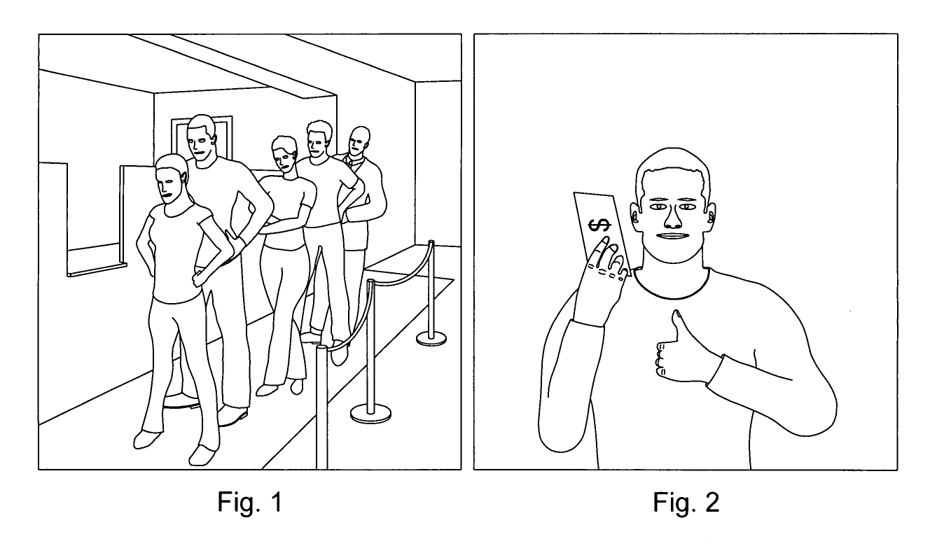

FIG. 2 shows illustrative perspective views of a central physical location in which people electronically execute bank transactions and a software CD that is mailed to a central processing facility for Bank Mall.

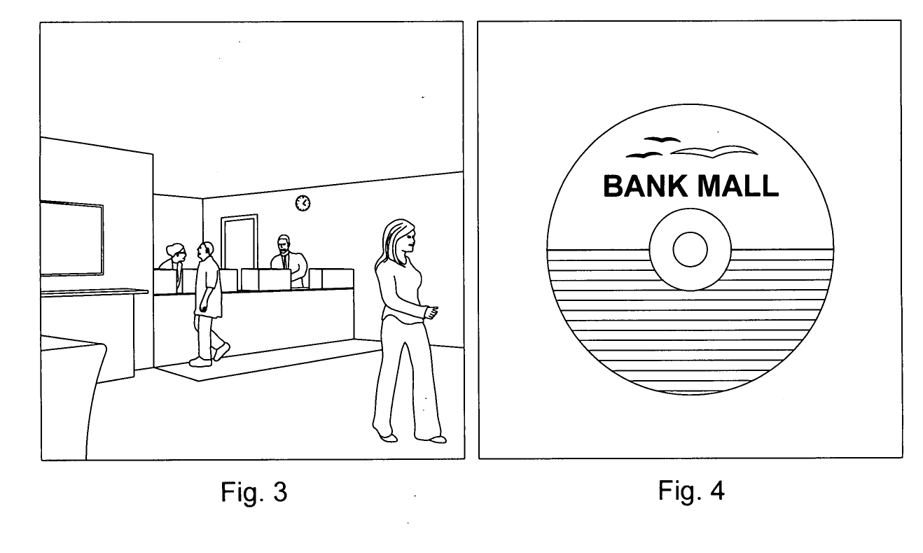

### DETAILED DESCRIPTION OF THE INVENTION

In a free market economy such as the United States, one is hard pressed to imagine what a life without banks. Providing a vast array of financial services ranging from deposits and check cashing to investments and loans for homes and cars, banks serve essential needs for economical survival. Even in today's electronic society, where one accesses a bank account online or withdraws money from a machine, the word bank conjures images of a series of busy tellers behind a counter taking care of a snaking line of customers that seems to be endless. This scenario still is a ubiquitous one in thousands of commercial banks. A trip to the bank sometimes proves to be a time consuming endeavor. Particularly, businesses needing banking services tend to spend the most time taking care of financial needs, from making several large deposits at once to paying on business loans to getting large change orders. Depending on the size of a business, this process may be endured at several different banks since the Federal Deposit Insurance Corporation only insures deposits up to $250,000 per depositor per bank. These businesses often find that a significant portion of their days are used just to attend to banking.

The present invention, hereinafter referred to as Bank Mall, is a messenger service for businesses as well as consumers that provides delivery and pickup of banking transactions for them, saving them the time and hassle of physically visiting a bank. It is an additional object of the present invention to provide the ability to make a deposit at any bank to any other bank. The invention also provides a bank branch location having branches for multiple banking institutions at one location. Additionally, the present invention provides the ability to make a deposit at any bank to any other bank.

For the pick up and delivery services, the Bank Mall service charges clients a flat monthly fee or per transaction fee for completing the banking transactions. A first embodiment of Bank Mall is to contract with a business to provide agents who serve as messengers for the business. These agents visit an establishment, pick up transactions and physically deliver these transactions to each bank used by the business. The agent messenger returns to the client with receipts and change orders. A second embodiment for Bank Mall is to provide one centralized location that possesses teller windows designated for several different banks, providing one stop banking for those people using multiple institutions. This service accepts deposits and payments, as well as other banking services, such as opening an account, applying for a loan, etc. A third embodiment is to provide a window covering all banks with the Bank Mall establishment possessing proprietary computer software that links to their contracted banks, allowing the Bank Mall to process the transactions.

Using Bank Mall, business and commercial interests can delegate common banking transaction tasks to a third party, leaving the bank to attend to more important daily functions such as serving their clients and generating new business. People with jobs that preclude them from using a bank during normal business hours can have cash checks and make deposits while they are at work. Presented as a franchise opportunity, Bank Mall provides entrepreneurs a new lucrative business venture. Banks may decrease overhead and increase their bottom lines, as proliferation of this third party service eliminates the need to over saturate areas with multiple branches to accommodate high in bank traffic. Fully developed and implemented, the present invention will well received by a public at large, for business and personal banking.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An automated messenger service for a business or a consumer providing delivery and pickup of banking services, comprising:
contracting with a business or consumer to provide an agent who serves as a messenger for the business or consumer, wherein the agent performs the steps of:
visiting an establishment,
picking up transactions,
physically delivering the transactions to each bank used by the business or consumer, and
performing the banking service,
returning to the client with receipts and change orders; and
charging clients a flat monthly fee or per transaction fee for completing the banking transactions.

2. A method of providing banking services to provide the ability to make a transaction at any bank to any other bank comprising:
providing one centralized location that possesses teller windows designated for several different banks, wherein
the centralized location is capable of: accepting deposits for any of the different banks, accepting payments for any of the several different banks,
opening an account for any of the several different banks, and
applying for a loan from any of the several different banks.

3. The method of providing banking services of claim 2, wherein the one centralized location possesses teller windows designated for the several different banks.

4. The method of providing banking services of claim 2 further comprising providing computer software that links to the several different contracted banks, allowing the software to process a transaction.
